(19) United States
(12) Patent Application Publication
(10) Pub. No.: US 2022/0145078 A1
(43) Pub. Date: May 12, 2022

(54) COMPOSITION COMPRISING AN OXIDIZED POLYETHYLENE WAX, A COLOR MASTERBATCH COMPRISING THE SAME, A PRODUCT COMPRISING THE COLOR MASTERBATCH AND THE USE OF THE COLOR MASTERBATCH

(71) Applicant: Thai Polyethylene Co., Ltd., Bangkok (TH)

(72) Inventors: Pattarit SAHASYODHIN, Bangkok (TH); Paweena LERTCHANYAKUL, Bangkok (TH)

(21) Appl. No.: 17/427,197

(22) PCT Filed: Apr. 6, 2020
(86) PCT No.: PCT/EP2020/059779

§ 371 Date: Jul. 30, 2021

(30) Foreign Application Priority Data
Apr. 26, 2019 (EP) 19171381.7

(51) Int. Cl. C08L 91/06; C08J 3/22; C08L 27/06

(52) U.S. Cl. CPC C08L 91/06; C08J 3/226; C08L 2203/18; C08L 2310/00; C08L 2205/035; C08L 27/06

(57) ABSTRACT

The present invention relates to a composition comprising an oxidized polyethylene wax, wherein, the composition has an acid value of 11 to 15 mgKOH/g, preferably 12 to 15 mgKOH/g, even more preferred 12 to 14 mgKOH/g according to ASTM D1386 with respect to the total weight of the oxidized polyethylene wax, a weight average molecular weight from 2,000 to 12,000 g/mol, preferably 4,000 to 9,000 g/mol, even more preferred 5,000 to 8,000 g/mol determined according to gel permeation chromatography; and a density from 0.92 to 0.99 g/cm³, preferably 0.93 to 0.97 g/cm³, even more preferred 0.93 to 0.95 g/cm³ according to ASTM D1505, a masterbatch comprising the same, products comprising the masterbatch and the use of the masterbatch and the composition.

The present invention relates to a composition comprising an oxidized polyethylene wax. Furthermore, the invention relates to a color masterbatch and a product comprising the same. Finally, the invention relates to the use of the color masterbatch.

A color masterbatch is a solid or liquid additive for coloring plastics. A masterbatch as referred to herein is a concentrated mixture of pigments and/or additives encapsulates during a heat process into a carrier resin which is then cooled and processed thereafter.

Color masterbatches comprise, besides the coloring pigment, normally dispersing agents.

A variety of color masterbatch compositions and dispersing agents for use therein is known in the art.

U.S. Pat. No. 4,544,694 discloses an extrusion lubricant composition. The composition is an extrusion lubricant composition for working surface of an extrusion die for plastic processing, for example polyvinyl chloride, chlorinated vinyl chloride, polyvinylidene chloride or its copolymers.

U.S. Pat. No. 3,278,513 discloses a process for oxidizing linear low molecular weight polyethylene. Specific oxidation process operating conditions are described for manufacturing high quality oxidized wax products.

U.S. Pat. No. 3,293,112 discloses a method for preparing oxidized polyolefin waxes. In detail, preparing oxidized waxes of predetermined acid number and useful to form emulsions is described.

However, products prepared using color masterbatches (and dispersing agents comprised therein) known in the art often suffer from poor mechanical properties.

It is therefore the object of the present invention to provide a novel composition for use in color masterbatches overcoming drawbacks of the prior art, in particular suitable to improve the mechanical properties of a product comprising the color masterbatch.

This object is achieved by a composition comprising an oxidized polyethylene wax, wherein the composition has an acid value of 11 to 15 mgKOH/g, preferably 12 to 15 mgKOH/g, even more preferred 12 to 14 mgKOH/g according to ASTM D1386 with respect to the total weight of the oxidized polyethylene wax, a weight average molecular weight from 2,000 to 12,000 g/mol, preferably 4,000 to 9,000 g/mol, even more preferred 5,000 to 8,000 g/mol determined according to gel permeation chromatography; and a density from 0.92 to 0.99 g/cm³, preferably 0.93 to 0.97 g/cm³, even more preferred 0.93 to 0.95 g/cm³ according to ASTM D1505.

It has surprisingly been found by the inventors that the color masterbatch comprising the inventive composition is helpful to improve the mechanical properties of an article comprising the same. The advantageous impact on the mechanical properties was found to be even more pronounced the below preferred embodiments and combinations thereof.

A polyethylene wax as referred to herein is a polyethylene which has a waxy or fatty character. It can be produced with regulators substance by polymerization of ethylene or by depolymerization of polyethylene with higher molecular weight. It is mainly produced by thermal cracking at 400° C. but can also be synthesized from natural waxes.

By oxidation of the polyethylene wax, an oxidized polyethylene wax is achieved. This may contain a variety of carboxylic acid groups.

The acid value is the mass of potassium hydroxide in mg that is required to neutralize one gram of the oxidized polyethylene wax. The acid number is a measure of the number of carboxylic acid groups in the oxidized polyethylene wax. In a typical procedure, a known amount of samples dissolved in an organic solvent and treated with a solution of potassium hydroxide of known concentration using phenolphthalein as a color indicator is used to determine the acid number.

In a preferred embodiment, the composition has a viscosity from 80 to 1,500 cP at 149° C., preferably 100 to 600 cP at 149° C., even more preferred 130 to 250 cP at 149° C. according to ASTM D3236.

Preferably, the composition has a viscosity from 130 to 170 cP at 149° C.

In a further preferred embodiment, the composition has a density from 0.94 to 0.95 g/cm3.

Preferably, the composition comprises a) 100% by weight of the oxidized polyethylene wax having an acid value of n to 15 mgKOH/g; or b) 70 to 100% by weight, preferably 70 to 85% by weight of an oxidized polyethylene wax having an acid value from 17 to 18 mgKOH/g and 0 to 30% by weight, preferably 15 to 30% by weight of a polyethylene homopolymer wax with respect to the total weight of the composition, respectively.

In the above alternative (b) wherein the composition comprises an oxidized polyethylene wax having an acid number from 17 to 18 mgKOH/g, the respective oxidized polyethylene wax is “diluted” with the polyethylene homopolymer wax to adjust the acid value.

In another preferred embodiment, the composition has a density from 0.93 to 0.94 g/cm³.

Preferably, the composition has a viscosity from 150 to 250 cP at 149° C.

Further preferred, the polyethylene homopolymer wax has a viscosity from 80 to 1,500 cP at 149° C., preferably 100 to 1,200 cP at 149° C., even more preferred 200 to 1,000 cP at 149° C.

In a further preferred embodiment, the polyethylene homopolymer wax has a density from 0.91 to 0.96 g/cm³, preferably 0.91 to 0.95 g/cm³, even more preferred 0.91 to 0.93 g/cm³.

It may be further preferred that the polyethylene homopolymer way has a weight average molecular weight from 2,000 to 12,000 g/mol, preferably 2,000 to 10,000 g/mol, even more preferred 3,000 to 10,000 g/mol determined according to gel permeation chromatography.

The object is further achieved by a color masterbatch comprising the inventive composition and at least one pigment.

In terms of the present invention a color masterbatch is an additive for coloring a plastic. The color masterbatch according to the invention can be used in application (for coloring) of many types of polymers including polyvinylchloride (PVC), chlorinated polyvinylchloride (CPVC), polyethyleneterephthalate (PET), polybutyleneterephthalate (PBT), acrylonitrile butadiene styrene (ABS), polyamide (PA), polycarbonate (PC), and polyolefin (PO), wherein PVC is most preferred, The color masterbatch comprises at least one pigment. Furthermore, the color masterbatch in accordance with the invention comprises the inventive composition which may be used in this regard as a dispersing agent.

Preferably, the pigment wherein the pigment is selected from the group consisting of organic pigments, inorganic pigments or a combination thereof, preferably is selected from the group consisting of phthalocyanines, ultramarines and mixtures thereof.

The object is further achieved by a product comprising polyvinyl chloride and the inventive color masterbatch.

The inventive product is preferably selected from a pipe, a window profile, a door profile, a siding or a window frame, a door frame, a sheet or a floor.

Finally, the object is achieved by the use of the color masterbatch as referred to herein in extrusion molding or injection molding.

Finally, the object is achieved by the use of the composition as defined herein as a dispersing agent.

“Comprising” as used herein may (but not has to) have the meaning “consisting of”.

Methods for Determining Parameters:

The acid value as referred to herein was determined by titration with KOH according to ASTM D1386.

The viscosity as referred to herein is the Brookfield viscosity determined according to ASTM D3236.

The density as referred to herein was determined using a gradient tube according to ATSM D1505.

The weight average molecular weight as referred to herein is determined using gel permeation chromatography. MW measured by Gel Permeation Chromatography (GPC). Around 24 mg of sample was dissolved in 8 ml of 1,2-dichlorobenzene at 1500° C. for 60 min. Then the sample solution, 200 pA, was injected into the high temperature GPC with IR4 detectors (Polymer Char, Spain) with flow rate of 1 ml/min at 1400° C. in column zone and 1500° C. in detector zone. The data was processed by GPC One® software, Polymer Char, Spain.

Tensile strength and strain were determined according to ASTM D638. Strength of knit-line can indicate the material can prevent or encourage fusion of PVC.

Torque as referred to herein indicates the influence of the waxes on the ability of PVC to fuse and create torque on extruder. In accordance with the present disclosure, the torque is recorded on the extruder during processing.

Powder flow as referred to herein was observed during process. Poor means fine fluffy pigment that did not flow well in the PVC powder.

Gloss as referred to herein was determined according to ASTM D523 and indicates flow at surface and melt fracture. The gloss is quantified by comparison with a standard which as a gloss of 5=high gloss.

Pigment streaks were determined using a magnifying glass and streaks counted for 25 in² of surface area. This test indicated the ability of pigments to disperse in PVC.

In the following, the invention will be described in greater detail with reference to specific examples without, however, limiting the scope of the invention necessarily to those specific examples. Rather, one or more of the specific features disclosed with respect to the examples may be used in combination with one or more of the embodiments referred to above to realize the invention.

Four different compositions W-1, W-2, W-3 and W-4 comprising an oxidized polyethylene wax in accordance with the invention have been prepared.

| | | | | MW |
|---|---|---|---|---|
| | Acid number | Viscosity (cP | Density | by |
| Products | (mg KOH/g) | @ 149° C.) | (g/cm3) | GPC |
| W-1 | 12.2 | 159 | 0.938 | 5350 |
| Oxidized wax | | | | |
| W-2 | 12.3 | 165 | 0.935 | 6135 |
| Blending between oxidized | | | | |
| wax (17.8 mg KOH/g) and | | | | |
| homo PE wax (the ratio is | | | | |
| 69:31) | | | | |
| W-3 | 6.8 | 169 | 0.932 | 5779 |
| Oxidized wax | | | | |
| W-4 | 18.2 | 141 | 0.941 | 5165 |
| Oxidized wax | | | | |

The above compositions W-1, W-2, W-3 and W-4 Were umed for preparing a variety of masterbatches (examples 5 to 12). Furthermore, comparative masterbatches were prepared (examples 1 to 4). The masterbatches were tested in PVC.

TABLE 1
Processing parameters

| | | | Temp | Temp | | | Powder |
|---|---|---|---|---|---|---|---|
| No. | Wax | Pigment | Barrel | Melt | Torque | Pressure | Flow |
| 1 | No | No | 375 | 368 | 10368 | 469 | |
| 2 | No | Phth | 375 | 367 | 10200 | 425 | POOR |
| 3 | No | Ultm | 375 | 368 | 8750 | 389 | |
| 4 | Commercial | Phth | 375 | 368 | 10830 | 418 | |
| 5 | W-1 | Phth | 375 | 370 | 10810 | 419 | |
| 6 | W-2 | Phth | 375 | 367 | 9385 | 425 | |
| 7 | W-1 | Ultm | 375 | 368 | 10244 | 396 | |
| 8 | W-2 | Ultm | 375 | 371 | 8565 | 389 | |

TABLE 2
PVC product properties

| | | | | | Fraction | Pigment | |
|---|---|---|---|---|---|---|---|
| | | | | Strain | yield | Streaks | Gloss |
| No. | Wax | Pigment | Tensile | % | 1 = yield | 0 = none | 5 = high |
| 1 | No | No | 6090 | 10.3 | 0.8 | 0 | 5 |
| 2 | No | Phth | 6062 | 7.0 | 0 | 0 | 4.5 |
| 3 | No | Ultm | 5954 | 9.0 | 1.0 | 2 | 4.5 |
| 4 | Commercial | Phth | 6285 | 6.8 | 0 | 4 | 3 |
| 5 | W-1 | Phth | 6465 | 8.3 | 1.0 | 0 | 4.5 |
| 6 | W-2 | Phth | 6276 | 7.5 | 0.8 | 0 | 4.5 |
| 7 | W-3 | Phth | 5984 | 6.1 | 0.2 | 2 | 3 |
| 8 | W-4 | Phth | 6078 | 6.4 | 0 | 2 | 3 |
| 9 | W-1 | Ultm | 6058 | 11.6 | 1.0 | 2 | 4 |
| 10 | W-2 | Ultm | 6084 | 8.7 | 0.8 | 1 | 4 |
| 11 | W-3 | Ultm | 5790 | 7.8 | 0.2 | 2 | 3 |
| 12 | W-4 | Ultm | 4919 | 6.3 | 0.4 | 2 | 3.5 |

Methodology and formulation of the above examples are shown below.

1. Color Masterbatch Preparation
1. Set Brabender Mixer at 260° F. (125° C.).
2. Add 36 gram of pigment and 24 gram of W-1, W-2, W-3, W-4 at 5 rpm. When it looks like the wax has melted, turn up to 20 rpm and mix 3 minutes.
3. Cool in the Brabender at 0 rpm and remove master-batch.
4. The bowl was taken apart and material was chipped and scraped from rotors and bowl,
5. Grind to a powder.

| Composition | gram |
|---|---|
| Pigment | 36 |
| W-1, W-2, W-3, W-4 | 24 |

2. The PVC Siding Powder Formulation (General Formulation of PVC Siding Powder)

| Composition | phr |
|---|---|
| PVC resin, IV 0.92, K-67 | 100 |
| Tin stabilizer | 2 |
| Calcium Stearate | 0.8 |
| Paraffin wax | 1.2 |
| Oxidized PE wax | 0.2 |
| Calcium Carbonate | 3.0 |
| Acrylic impact modifier | 6.0 |
| Processing aid | 1.0 |
| Titanium Dioxide | 9.0 |

3. Mixing Color Masterbatch and Siding Powder by Extrusion

| Composition | gram |
|---|---|
| Siding powder | 2000 |
| Color masterbatch | 40 |

Melt temperature, torque and die pressure are extrusion parameters. Wax act as dispersant in color masterbatch should not be effect to these parameter. From the table 1, these parameters are not changed when W-1 added. This means that the processing is similar in extrusion parameters without color masterbatch.

From the table 1, powder flow is poor in sample without wax, but powder flow is better when dispersant added.

Tensile and strain are key parameters to indicate that PVC entanglement. When entanglement is strong, the PVC can elongate before rupture, this is the good point. From table 2, sample no. 5 (W1 added) show the highest in term of tensile and strain. So, our W1 has shown an excellent result for compatibility and entanglement.

The features disclosed in the foregoing description, in the claims and/or in the accompanying drawings may, both separately and in any combination thereof, be material for realizing the invention in diverse forms thereof.

1. A composition comprising an oxidized polyethylene wax, wherein the composition has an acid value of 11 to 15 mgKOH/g according to ASTM D1386 with respect to the total weight of the oxidized polyethylene wax, a weight average molecular weight from 2,000 to 12,000 g/mol determined according to gel permeation chromatography; and a density from 0.92 to 0.99 g/cm³ according to ASTM D1505.

2. The composition according to claim 1, wherein the composition has a viscosity from 80 to 1,500 cP at 149° C. according to ASTM D3236.

3. The Composition according to claim 1, wherein the composition has a viscosity from 130 to 170 cP at 149° C.

4. The composition according to claim 1, wherein the density is from 0.94 to 0.95 g/cm³.

5. The composition according to claim 1, wherein the composition comprises 70 to 85% by weight of an oxidized polyethylene wax having an acid value from 17 to 18 mgKOH/g and 15 to 30% by weight of a polyethylene homopolymer wax with respect to the total weight of the composition, respectively.

6. The composition according to claim 5, wherein the density is from 0.93 to 0.94 g/cm³.

7. The composition according to claim 5, wherein the composition has a viscosity from 150 to 250 cP at 149° C.

8. The composition according to claim 5, wherein the polyethylene homopolymer wax has a viscosity from 80 to 1,500 cP at 149° C.

9. The composition according to claim 5, wherein the polyethylene homopolymer wax has a density from 0.91 to 0.96 g/cm³.

10. The composition according to claim 5, wherein the polyethylene homopolymer wax has a weight average molecular weight from 2,000 to 12,000 g/mol, determined according to gel permeation chromatography.

11. A color masterbatch comprising the composition of claim 1 and at least one pigment.

12. The color masterbatch according to claim 11, wherein the pigment is selected from the group consisting of organic pigments, inorganic pigments or a combination thereof.

13. A product comprising a polymer and the color masterbatch according to claim 11.

14. The product according to claim 13, wherein the polymer is selected from the group consisting of polyvinylchloride, chlorinated polyvinyl chloride, polyethylene terephthalate, polybutylene terephthalate, acrylonitrile butadiene styrene, polyamide, polycarbonate, polyolefin and mixtures thereof.

15. The product according to claim 13, wherein the product is selected from a pipe, a window profile, a door profile, a siding or a window frame, a door frame, a sheet or a floor.

16. A process comprising using the color masterbatch according to claim 11 in extrusion molding or injection molding.

17. A process comprising using the composition according to claim 1 as a dispersing agent.

18. The composition according to claim 1, wherein the acid value is from 12 to 15 mgKOH/g according to ASTM D1386.

19. The composition according to claim 1, wherein the weight average molecular weight is from 4,000 to 9,000 g/mol determined according to gel permeation chromatography.

20. The composition according to claim 1, wherein the density is from 0.93 to 0.97 g/cm³ according to ASTM D1505.
